(19) United States
(12) Patent Application Publication
(10) Pub. No.: US 2015/0077547 A1
(43) Pub. Date: Mar. 19, 2015

(54) ATTITUDE MEASUREMENT BETWEEN OPTICAL DEVICES

(71) Applicant: BAE SYSTEMS INFORMATION AND ELECTRONIC SYSTEMS INTEGRATION INC., Nashua, NH (US)

(72) Inventor: MICHAEL J. CHOINIERE, Merrimack, NH (US)

(21) Appl. No.: 14/554,109

(22) Filed: Nov. 26, 2014

Related U.S. Application Data
(63) Continuation-in-part of application No. 13/904,046, filed on May 29, 2013.
(60) Provisional application No. 61/909,855, filed on Nov. 27, 2013.

(51) Int. Cl. G01B 11/26

(52) U.S. Cl. CPC G01B 11/26
USPC 348/135

(57) ABSTRACT

A system for measuring an attitude between optical devices is disclosed. In an embodiment, the system includes a plurality of optical devices and a hub. Further, the hub includes a plurality of attitude measurement and control subsystems (AMCSs) that are aligned with a predetermined angle during factory calibration. Each AMCS is connected to one of the optical devices and each AMCS measures an attitude between an AMCS and a corresponding optical device connected to the AMCS. Furthermore, the hub includes an attitude measurement unit to measure the attitude between the optical devices based on the measured attitude between each AMCS and a corresponding connected optical device and the predetermined angle between the AMCSs.

### CROSS-REFERENCE TO RELATED APPLICATIONS

This application claims rights under 35 U.S.C. 119(e) from U.S. Application No. 61/909,855 filed Nov. 27, 2013, entitled ATTITUDE MEASUREMENT ATTITUDE SUBSYSTEM (AMCS) HUB and also this application claims rights under 35 U.S.C. 120 from U.S. application Ser. No. 13/904,046 filed May 29, 2013, entitled “OPTICAL AUTOMATIC ATTITUDE MEASUREMENT FOR LIGHTWEIGHT PORTABLE OPTICAL SYSTEMS”, and the contents of which are incorporated herein by reference.

### BACKGROUND OF THE INVENTION

1. Field of the Invention

The present invention relates to optical devices and more particularly to an attitude measurement between the optical devices.

2. Brief Description of Related Art

In a typical optical system (e.g., a lightweight laser designator rangefinder), multiple optical devices need to be aligned to reduce error in target computations. Existing approach may use large and heavy mechanical interfaces (couplings) between the optical devices to hold the optical devices tightly and to ensure good alignment from tolerance perspective. However, such large and heavy mechanical interfaces may be sensitive and result in misalignment and unexpected errors when the interfaces get fouled, dirty, and/or banged.

### SUMMARY OF THE INVENTION

A system for measuring an attitude between optical devices is disclosed. According to an aspect of the present subject matter, the system includes a plurality of optical devices and a hub. Further, the hub includes a plurality of attitude measurement and control subsystems (AMCSs) that are aligned with a predetermined angle during factory calibration. Each AMCS is connected to one of the optical devices and each AMCS measures an attitude between an AMCS and a corresponding optical device connected to the AMCS. Furthermore, the hub includes an attitude measurement unit to measure the attitude between the optical devices based on the measured attitude between each AMCS and a corresponding connected optical device and the predetermined angle between the AMCSs.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a block diagram of a system for measuring an attitude between optical devices, according to an example embodiment of the present subject matter.

FIG. 2 is a block diagram of a system for measuring an attitude between an attitude measurement and control subsystem (AMCS) and an optical device connected to the AMCS, according to an example embodiment of the present subject matter.

FIG. 3 is a schematic illustrating a captured image including two dots associated with a reference beam and an attitude beam, according to an example embodiment of the present subject matter.

FIG. 4 is a schematic illustrating effects of yaw movement between the AMCS and the optical device, such as those shown in FIG. 2, on the captured image including the two dots, according to an example embodiment of the present subject matter.

FIG. 5 is a schematic illustrating effects of pitch movement between the AMCS and the optical device, such as those shown in FIG. 2, on the captured image including the two dots, according to an example embodiment of the present subject matter.

FIG. 6 is a schematic illustrating effects of roll movement between the AMCS and the optical device, such as those shown in FIG. 2, on the captured image including the two dots, according to an example embodiment of the present subject matter.

FIG. 7 is a schematic illustrating effects of roll movement between a light source and a camera, such as those shown in FIG. 2, on the captured image including the two dots, according to an example embodiment of the present subject matter.

### DETAILED DESCRIPTION OF THE INVENTION

The exemplary embodiments described herein in detail for illustrative purposes are subject to many variations in structure and design. The present technique proposes a hub approach that allows connecting multiple optical devices to a hub that includes multiple attitude measurement and control subsystems (AMCSs) aligned with a predetermined angle during factory calibration. Further, each AMCS establishes communication and measures an attitude between an AMCS and a corresponding optical device connected to the AMCS. For example, the attitude is an offset angle, such as a pitch angle, a yaw angle and/or a roll angle. Furthermore, an attitude measurement unit in the hub measures an attitude between the optical devices by summing the offset angle between each AMCS and the corresponding connected optical device and the predetermined angle between the AMCSs. The optical devices can then be aligned based on the measured attitude.

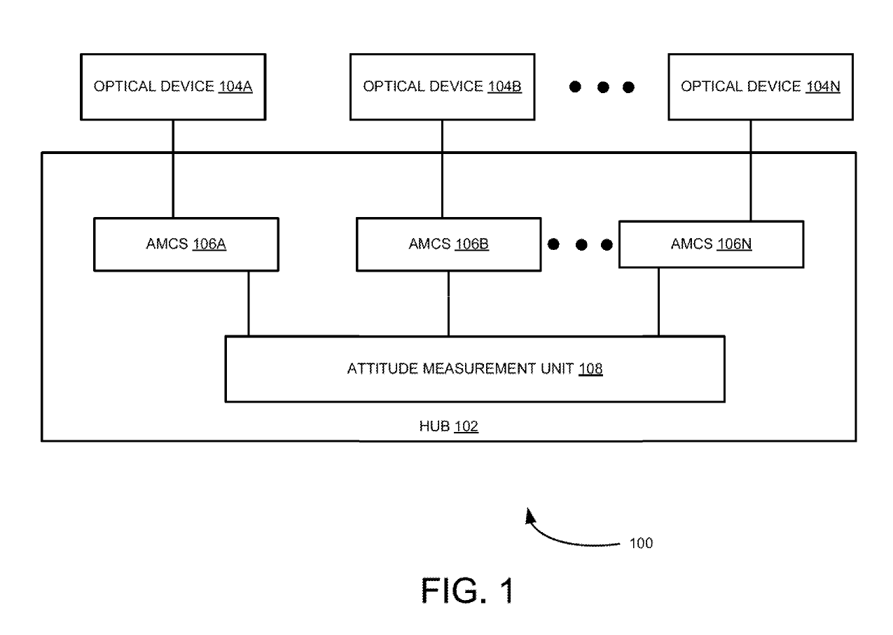

FIG. 1 is a block diagram of a system 100 for measuring an attitude between optical devices 104A-N, according to an example embodiment of the present subject matter. As shown in FIG. 1, the system 100 includes a hub 102 and the optical devices 104A-N connected to the hub 102. Example optical devices include designators, sights, inertial measurement units (IMUs), vehicle optics and the like. Further, the hub 102 includes AMCSs 106A-N aligned with a predetermined angle during factory calibration and an attitude measurement unit 108 connected to the AMCSs 106A-N. For example, the predetermined angle between the AMCSs 106A-N include a predetermined angle between the AMCSs 106A and 106B, the AMCSs 106A and 106N and the AMCSs 106B and 106N. In the example illustrated in FIG. 1, the AMCSs 106A-N are connected to the optical devices 104A-N, respectively. In this example, the AMCS 106A is connected to the optical device 104A, the AMCS 106B is connected to the optical device 104B and the AMCS 106N is connected to the optical device 104N.

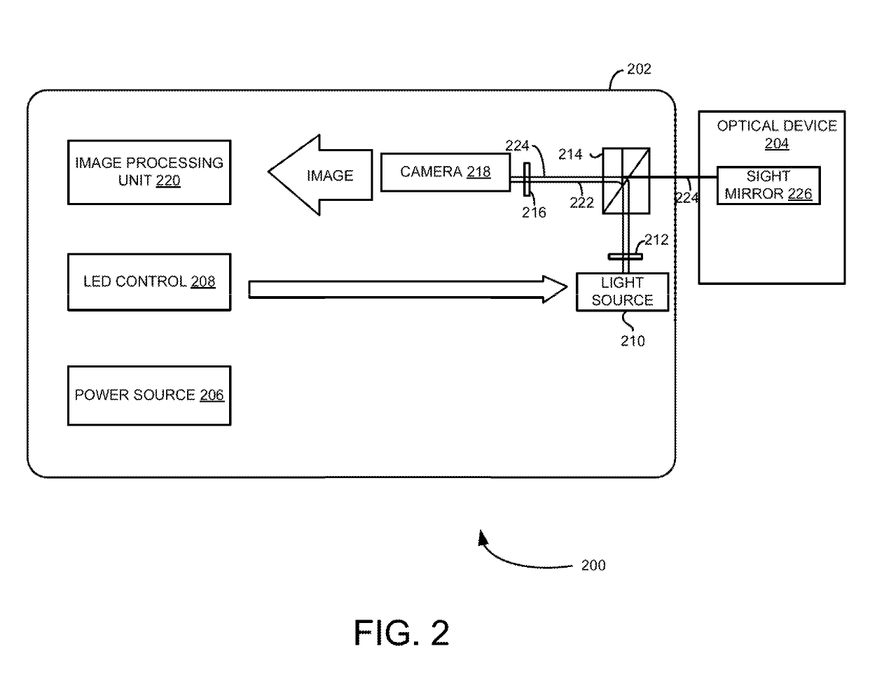

In operation, the AMCS 106A measures an attitude between the AMCS 106A and the optical device 104A, the AMCS 106B measures an attitude between the AMCS 106B and the optical device 104B and the AMCS 106N measures an attitude between the AMCS 106N and the optical device 104N. This is explained in more detailed with reference to FIG. 2. For example, the attitude is an offset angle, such as a pitch angle, a yaw angle and/or a roll angle.

Further, the attitude measurement unit 108 measures the attitude between the optical devices 104A-N based on the offset angle between the AMCS 106A and the optical device 104A, the offset angle between the AMCS 106B and the optical device 104B, the offset angle between the AMCS 106N and the optical device 104N and the predetermined angle between the AMCSs 106A-N. For example, the attitude measurement unit 108 can be a processor programmed to co-ordinate information from the AMCSs 106A-N and measure the attitude between the optical devices 104A-N. In one embodiment, the attitude measurement unit 108 measures the attitude between the optical devices 104A-N by summing the offset angle between the AMCS 106A and the optical device 104A, the offset angle between the AMCS 106B and the optical device 104B, the offset angle between the AMCS 106N and the optical device 104N and the predetermined angle between the AMCSs 106A-N. In another embodiment, the attitude measurement unit 108 measures the attitude between the optical devices 104A-N by summing an offset angle of each of the AMCS 106A-N to a standard normal mirror in the factory calibration, an offset angle between the mirror normal to components within each of the optical devices 104A-N in the factory calibration, the measured offset angle between the AMCS 106A and the optical device 104A, the measured offset angle between the AMCS 106B and the optical device 104B, and the measured offset angle between the AMCS 106N and the optical device 104N.

FIG. 2 is a block diagram of a system 200 for measuring an attitude between an AMCS 202 (e.g., any of the AMCSs 106A-N shown in FIG. 1) and an optical device 204 connected to the AMCS 202 (e.g., a corresponding optical device 104A-N connected to one of the AMCSs 106A-N as shown in FIG. 1), according to an example embodiment of the present subject matter. As shown in FIG. 2, the AMCS 202 includes a power source 206, a light emitting diode (LED) control 208, a light source 210, a first collimating optic device 212, a beam splitter cube 214, a second collimating optic device 216, a camera 218 and an image processing unit 220 coupled to the camera 218. Further as shown in FIG. 2, the optical device 204 includes a sight mirror 226.

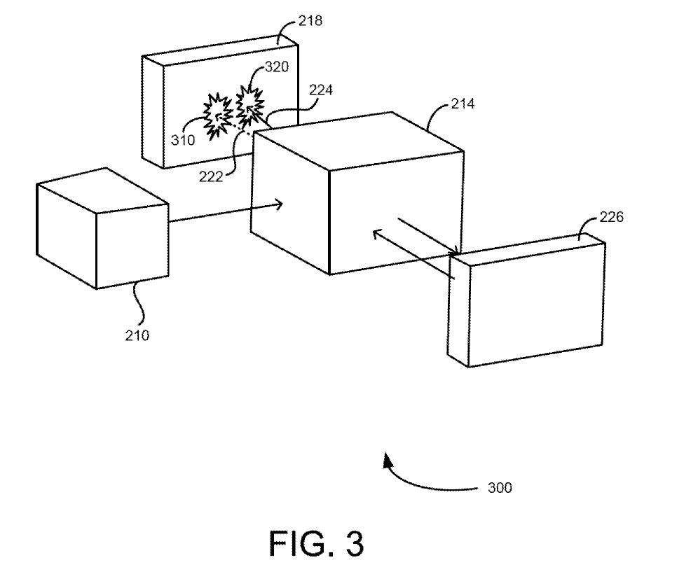

In operation, the light source 210 generates a beam. Exemplary light source 210 is a LED and the like. In the example illustrated in FIG. 2, the power source 206 provides needed power to the light source 210 to generate the beam. In this example, the light source 210 is controlled by the LED control 208. The beam is then passed through the first collimating optic device 212 that collimates the generated beam and directs the collimated beam towards the beam splitter cube 214. The beam splitter cube 214 then receives the collimated beam from the first collimating optic device 212 and splits the collimated beam into a reference beam 222 and an attitude beam 224. In an example, the beam splitter cube 214 is configured so that the reference beam 222 goes through the beam splitter cube 214 and reflects back as shown in FIG. 2. The beam splitter cube 214 is also configured to reflect the attitude beam 224 and direct the reflected attitude beam 224 towards the sight minor 226 in the optical device 204. Upon receiving the attitude beam 224 from the beam splitter cube 214, the sight mirror 226 reflects the attitude beam 224 back to the beam splitter cube 214 as shown in FIG. 2. The beam splitter cube 214 then receives attitude beam 224, from the sight minor 226, and directs the attitude beam 224 along with the reflected reference beam 222 towards the camera 218. In some embodiments, the beam splitter cube 214 directs the attitude beam 224 along with the reference beam 222 towards the camera 218 via the second collimating optic device 216 that further collimates the attitude beam 224 and the reference beam 222. The camera 218 then receives the reference beam 222 and the attitude beam 224 from the beam splitter cube 214 or second collimating optic device 216. The received reference beam 222 and attitude beam 224 illuminate the camera 218 and generate associated two dots 310 and 320 on a captured image as shown in FIG. 3.

In addition, the image processing unit 220 measures the attitude between the AMCS 202 and the optical device 204 by computing a differential measurement between the reference beam 222 and the attitude beam 224 in x and y planes using the associated two dots 310 and 320, formed on the captured image by the camera 218. In an example implementation, the image processing unit 220 determines a center of each of the two dots 310 and 320 and computes a pixel distance between the centers of the two dots 310 and 320 in the x and y planes. In this example implementation, the reference beam 222 and the attitude beam 224 are configured to produce the two dots 310 and 320, on the captured image, having a predetermined size that is suitable for the image processing unit 220 to determine the centers of the two dots 310 and 320 to single pixel accuracy. The image processing unit 220 uses well known centroiding algorithms to determine the centers of the two dots 310 and 320. The image processing unit 220 then measures the attitude between the AMCS 202 and the optical device 204 based on the computed pixel distance between the centers of the two dots 310 and 320 in the x and y planes.

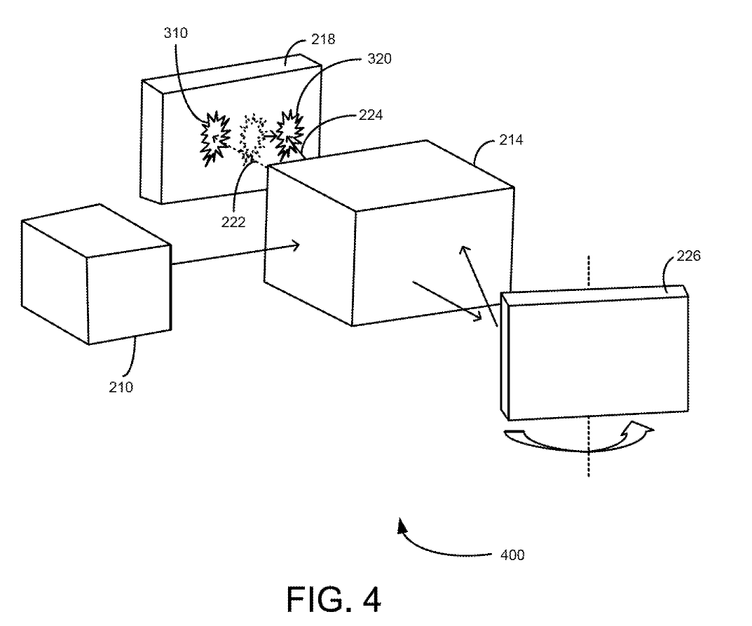

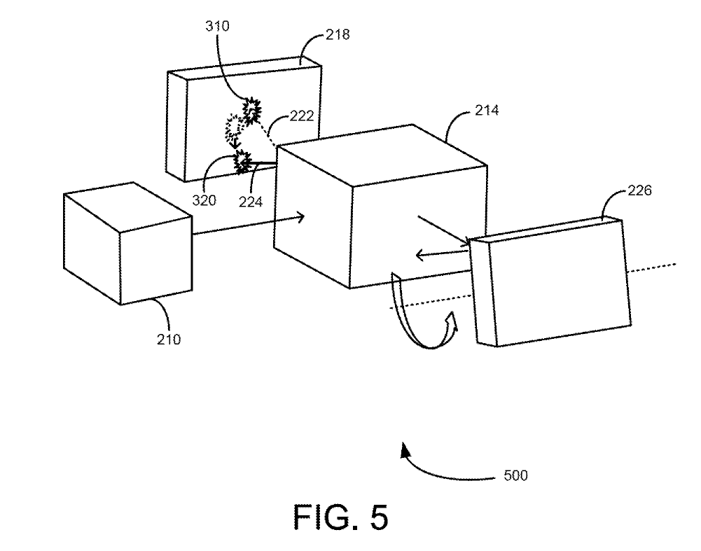

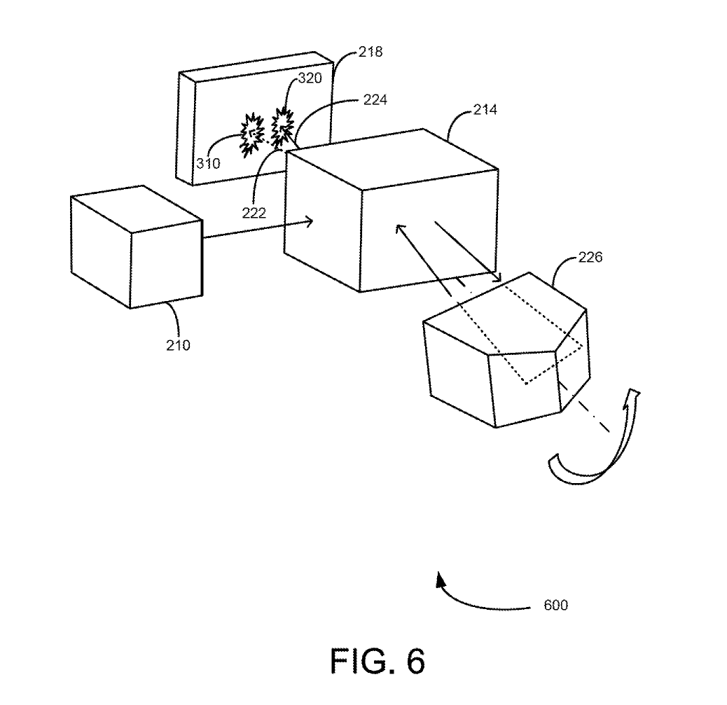

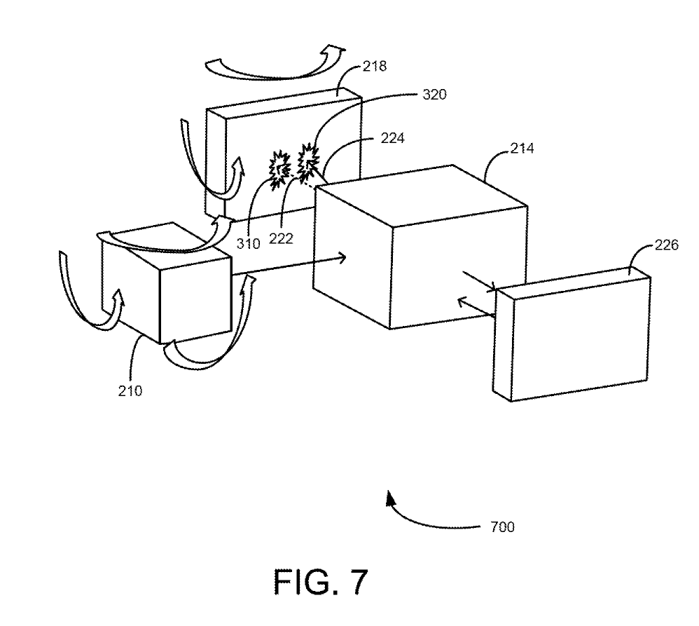

In some embodiments, based on the orientation of the sight mirror 226, the beam splitter cube 214 and the camera 218, the attitude between the AMCS 202 and the optical device 204 is determined. For example, as shown in a schematic 400 of FIG. 4, if the sight mirror 226 is rotated about its vertical axis and the beam splitter cube 214 is rotated within the plane of a paper (yaw movement), then the attitude manifests itself into an x-movement about the center of the dot 320. Similarly, as shown in a schematic 500 of FIG. 5, if the sight mirror 226 is rotated about its horizontal axis and the beam splitter cube 214 is rotated within the plane of the paper (pitch movement), then the attitude manifests itself into a y-movement about the center of the dot 320, while the front surface continues to act as a mirror providing both pitch and yaw measurements. Further as shown in a schematic 600 of FIG. 6, if the sight mirror 226 is configured as a dove prism and is rotated about its central axis and the beam splitter cube 214 is rotated within the plane of the paper (roll movement), then the dove prism 226 rotation does not manifest itself in any attitude change between the AMCS 202 and the optical device 204. Furthermore as shown in a schematic 700 of FIG. 7, any movement (roll movement) in the light source 210 and the camera 218 results in both the dots 310 and 320 moving together by a same amount resulting in no attitude manifestation.

The above proposed technique reduces weight and significantly improves tolerance to fouling in battlefield. Further, the above technique provides environmentally sensitive interfaces while maintaining high accuracy between optical devices in an optical system or a vehicle. Furthermore, the above technique is an active feedback system that dynamically provides the needed attitude measurement while the optical system is in operation. Moreover, the above technique significantly loosens up tolerance requirements to be maintained between the optical devices in the optical system. Also, the above technique is based on differential measurement and all components, which can move with environmental impacts that affect both the reference and attitude beams, thereby the final attitude measurement between the optical devices is differential in nature resulting in being impervious to the environmental conditions, such as temperature, shock, vibration and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A system, comprising:
a plurality of optical devices; and
a hub comprising:
a plurality of attitude measurement and control subsystems (AMCSs) that are aligned with a predetermined angle during calibration, wherein each of the plurality of AMCSs is connected to one of the plurality of optical devices and wherein each of the plurality of AMCSs measures an attitude between an AMCS and a corresponding optical device connected to the AMCS; and
an attitude measurement unit to measure an attitude between the plurality of optical devices based on the measured attitude between each of the plurality of the AMCSs and a corresponding connected optical device and the predetermined angle between the AMCSs.

2. The system of claim 1, wherein the attitude is an offset angle selected from the group consisting of a pitch angle, a roll angle and a yaw angle.

3. The system of claim 2, wherein the attitude measurement unit is to:
measure the attitude between the plurality of optical devices by summing the offset angle between each of the plurality of the AMCSs and the corresponding connected optical device and the predetermined angle between the AMCSs.

4. The system of claim 1, wherein the optical devices comprise designators, sights, inertial measurement units (IMUs) and vehicle optics.

5. The system of claim 1, wherein each of the plurality of optical devices comprises a sight mirror.

6. The system of claim 5, wherein each of the plurality of AMCSs comprises:
a light source to generate a beam;
a collimating optic device to collimate the generated beam;
a beam splitter cube to:
receive the collimated beam from the collimating optic device and split the collimated beam into a reference beam and an attitude beam; and
direct the attitude beam towards the sight mirror in the corresponding optical device connected to the AMCS and receive the reflected attitude beam from the sight mirror;
a camera to:
receive the reference beam and the attitude beam from the beam splitter cube, wherein the received attitude beam and the reference beam illuminate the camera and generate associated two dots on a captured image; and
an image processing unit coupled to the camera to:
measure the attitude between the AMCS and the corresponding optical device connected to the AMCS by computing a differential measurement between the reference beam and the attitude beam in x and y planes using the associated two dots on the captured image.

7. The system of claim 6, wherein the image processing unit is to:
compute a pixel distance between the two dots in the x and y planes; and
measure the attitude between the AMCS and the corresponding optical device connected to the AMCS based on the computed pixel distance between the two dots the x and y planes.

8. The system of claim 7, wherein the image processing unit is to:
compute a center of each of the two dots; and
compute the pixel distance between the centers of the two dots in the x and y planes.

9. A system, comprising:
a plurality of optical devices, wherein each of the plurality of devices comprises a sight mirror; and
a hub comprising:
a plurality of attitude measurement and control subsystems (AMCSs) that are aligned with a predetermined angle during factory calibration, wherein each of the plurality of AMCSs is connected to one of the plurality of optical devices and wherein each of the plurality of AMCSs comprises:
a light source to generate a beam;
a collimating optic device to collimate the generated beam;
a beam splitter cube to:
receive the collimated beam from the collimating optic device and split the collimated beam into a reference beam and an attitude beam; and
direct the attitude beam towards a sight mirror in a corresponding optical device connected to an AMCS and receive the reflected attitude beam from the sight mirror;
a camera to:
receive the reference beam and the attitude beam from the beam splitter cube, wherein the received attitude beam and the reference beam illuminate the camera and generate associated two dots on a captured image; and
an image processing unit coupled to the camera to:
measure the attitude between the AMCS and the corresponding optical device connected to the AMCS by computing a differential measurement between the reference beam and the attitude beam in x and y planes using the associated two dots on the captured image; and
an attitude measurement unit to measure an attitude between the plurality of optical devices based on the measured attitude between each of the plurality of AMCSs and a corresponding connected optical device and the predetermined angle between the AMCSs.
